(19) United States
(12) Patent Application Publication
(10) Pub. No.: US 2009/0156208 A1
(43) Pub. Date: Jun. 18, 2009

(54) Local network access using public cells

(75) Inventors: Seppo Vesterinen, Oulunsalo (FI); Matti Laitila, Oulu (FI)

Correspondence Address: HARRINGTON & SMITH, PC, 4 RESEARCH DRIVE, Suite 202, SHELTON, CT, 06484-6212, US

(73) Assignee: Nokia Siemens Networks Oy

(21) Appl. No.: 12/315,128

(22) Filed: Nov. 26, 2008

Related U.S. Application Data
(60) Provisional application No. 61/004,375, filed on Nov. 26, 2007.

(51) Int. Cl. H04W 4/00; H04W 36/00; H04W 24/00

(52) U.S. Cl. 455/435.1; 455/436; 370/338; 455/456.1; 455/466

(57) ABSTRACT

Disclosed herein are apparatus, method, and computer program whereby a cellular network base station operates with closed subscriber group indicator indicating off. The cellular network base station transmits information to a user equipment indicating the availability of a local service area network at a location in which the user equipment is currently located.

### CROSS-REFERENCE TO RELATED APPLICATIONS

This patent application claims priority under 35 U.S.C. §119(e) from U.S. Provisional Patent Application No. 61/004,375, filed Nov. 26, 2007, the disclosure of which is incorporated by reference herein in its entirety.

### TECHNICAL FIELD

The exemplary and non-limiting embodiments of this invention relate generally to wireless communication systems, methods, devices and computer program products and, more specifically, relate to techniques to provide local network access to user equipment.

### BACKGROUND

Various abbreviations that appear in the specification and/or in the drawing figures are defined as follows:

3GPP third generation partnership project
CSG closed subscriber group
CN core network
eNB EUTRAN Node B (evolved Node B)
EPC evolved packet core
EUTRAN evolved UTRAN
FDD frequency division duplex
FDMA frequency division multiple access
GW gateway
HSS home subscriber system
IMS IP multimedia system
IP internet protocol
LAN local area network
LTE long term evolution

### LTE-A LTE-advanced

MAC medium access control
MM mobility management
MME mobility management entity
NAS non-access stratum
Node B base station
OFDMA orthogonal frequency division multiple access
PDCP packet data convergence protocol
PDN packet data network
PLMN public mobile network
RLC radio link control
RRC radio resource control
RRM radio resource management
RSC retail sponsored communications
SAE system architecture evolution
SC-FDMA single carrier, frequency division multiple access
TA tracking area
UE user equipment
UTRAN universal terrestrial radio access network

A proposed communication system known as evolved UTRAN (EUTRAN, also referred to as UTRAN-LTE or as EUTRA) is currently under development within the 3GPP. The current working assumption is that the DL access technique will be OFDMA, and the UL access technique will be SC-FDMA.

One specification of interest that is related to EUTRAN is 3GPP TS 36.300, V8.2.0 (2007-09), 3rd Generation Partnership Project; Technical Specification Group Radio Access Network; Evolved Universal Terrestrial Radio Access (E-UTRA) and Evolved Universal Terrestrial Access Network (E-UTRAN); Overall description; Stage 2 (Release 8. The Annex F of this document “Mobility and Access Control Requirements associated with Closed Subscriber Group (CSG) Cells”, is of particular interest to the description of the various embodiments of this invention.

FIG. 1 reproduces FIG. 4 of 3GPP TS 36.300 and shows the overall architecture of the E-UTRAN system. The E-UTRAN system includes eNBs, providing the E-UTRA user plane (PDCP/RLC/MAC/PHY) and control plane (RRC) protocol terminations towards the UE. The eNBs are interconnected with each other by means of an X2 interface. The eNBs are also connected by means of an S1 interface to an EPC, more specifically to a MME by means of a S1-MME interface and to a Serving Gateway (S-GW) by means of a S1-U interface. The S1 interface supports a many-to-many relation between MMEs/Serving Gateways and eNBs.

3GPP has selected the LTE/SAE architecture, that is based on an evolution of the 3G packet core, and that is optimized for using services from the IMS that is located in proximity to a centralized SAE GW in the operator's domain. At present, connectivity to competitive Open Internet Services from local or external packet switched networks is considered to be secondary and non-optimal.

The LTE radio is very competitive, and its high throughput and low latency have the potential to advance the user end-to-end (e2e) experience to levels similar to those experienced in fixed broadband access. However, when the LTE radio is coupled with the selected “long distance carrier model” in the SAE architecture, where all calls/services are considered to be “long distance”, the e2e performance may be constrained because of distance (for the first time in a cellular network).

It is assumed that the localized services/access shall be provided by forming local service areas into a cellular operator's network (PLMN), i.e., they are assumed to be part of the public mobile network, especially due to the use of the licensed radio band.

3GPP RAN WG2 has currently specified Home Node B (HNB) and Closed Subscriber Group (CSG) concepts, where the CSG cells/base stations are owned or rented by subscribers (CSG owner). The CSG networks are assumed to be built of HNBs (e.g. “Femto” Base Stations) and the services are restricted for use only for subscribers owning the HNB(s), or those that have been granted access by the owner.

In a Local IP Breakout approach it is assumed that the local service areas could be formed anywhere in the PLMN using all available network resources. For example, a municipal communication service with full service coverage would require using public cells/base stations at the macro layer, in addition to the private Femto Base Stations. Implementing this approach, however, would require omitting current 3GPP defined limitations in access control of the local area scenarios defined for the CSG concept.

Reference in this regard may be made to commonly owned and copending U.S. Provisional Patent Application No. 60/993,291, filed Sep. 10, 2007, “Access Control for Closed Subscriber Groups”, Ivan Ore and Markus Dillinger. This document describes “open mode” CSG networks wherein the operator/CSG administrator allow access to guest members when required. The disclosed use of reverting a private cell to a public cell using a new Access Closed/Open Flag in cell broadcast system information enables users to connect to a CSG cell, e.g., to a Home NodeB, or to a community network built from multiple base stations that would normally be used for private access only.

This type of “open access” with CSG cells provides an ability to build 3G/LTE network coverage using relatively inexpensive Home NodeBs, and without any controlled radio network planning. In order to avoid interference to public cells the CSG networks may be placed on a different frequency layer that, in the case of 3G/LTE, belongs to the operator owned licensed band.

Another document of interest is Finland Patent Application no. 20075252, filed on Apr. 13, 2007 and entitled “Method, radio system, mobile terminal and base station”. This application describes the concept of “local breakout services” in which a user equipment detects availability of a local breakout service to an internet protocol gateway, starts network entry, and configures its protocol stack on the basis of configuration data received from the local breakout service. This local breakout service may be considered in some respects analogous to the home E-Node B and the CSG cells described in 3GPP TS 36.300 noted above.

The registered owner of the Home E-Node B adds subscribers to its user group, and it is those members of the user group that are allowed access to the CSG cell. Because one or more home e-node Bs can be linked to form more than one CSG cell contiguous with one another, it is convenient to term them a CSG network. A CSG network is a network composed of one or more cells with access permissions managed at least partially by final consumers. Those subscribers registered as members of the user group are CSG members. A CSG member is a wireless service (cellular) user registered to the CSG network by the CSG administrator, and once registered is allowed to access the CSG network. Those users or devices not registered to the CSG are not allowed access to it, hence the term closed subscriber group. In CSG networks, only the devices (user equipment or UEs) that have been granted permission to access a CSG network may camp or connect to that network. Examples of CSG cells include a Home E-Node B (LTE cells that are purchased by the consumer), corporate cells (cells that are hired or owned by a company), and “commercial” cells (cells that are owned by retailing companies, supermarkets, etc). It is the responsibility of the CSG administrator to register a user as CSG member.

While the CSG network can control and modify the subscribers that form its user group quickly, access is restricted to registered subscribers and closed to other users. The procedure in which a user is added as a CSG member of a CSG network is generally as follows. The CSG administrator adds the IMSI/IMEI or phone number to the operator's database; the operator sends a list of one or more CSG network identifiers to the user via NAS signaling; and once the user receives the NAS information, the user becomes a CSG member and therefore is allowed to access all the cells that belong to the same CSG network identifier.

Mobility of the user group members between the CSG network and other cells that are ‘open’ (non-CSG cells, whether they be E-UTRAN, UTRAN, GERAN, or others) is described also at Annex F referenced above so that user group members prioritize their CSG network over other cells when within range of the CSG network. In this manner the CSG concept expands overall coverage of the public, non-closed network, though only to the user group members.

The concept of the CSG networks may be considered useful in the context of a corporate or university campus, or a retail establishment. The corporation or university allows its employees/students free or low cost access to the CSG by enrolling them into the appropriate user group while restricting others from free riding on the service. Adding members to these groups on an ad hoc basis, such as visiting speakers or professors, is not a difficult matter as these additions will generally be only occasional.

Businesses on the other hand may wish to provide their customers with free or low cost access in order to lure them and encourage them to linger longer and possibly purchase more of the regular products or services of the business. For example, a restaurant or café may prefer to provide a free or low-cost Internet access to its customers in order that they choose that establishment over competitors and stay longer once there.

### SUMMARY

A first embodiment of the invention is a method comprising: operating a cellular network base station with closed subscriber group indicator indicating off; and transmitting information to a user equipment indicating the availability of a local service area network at a location in which the user equipment is currently located.

Another embodiment of the invention is a computer readable medium encoded with a computer program executable by a processor to perform actions comprising: operating a cellular network base station with closed subscriber group indicator indicating off; and transmitting information to a user equipment indicating the availability of a local service area network at a location in which the user equipment is currently located.

Another further embodiment of the invention is an apparatus comprising: a controller configured to operate a cellular network base station with closed subscriber group indicator indicating off; and a transmitter configured to send information to a user equipment indicating the availability of a local service area network at a location in which the user equipment is currently located.

Another further embodiment of the invention is a method comprising: receiving information at a user equipment from a cellular network base station, the base station having a closed subscriber group signaling indicator indicating off, and the information indicates the availability of a local service area network at a location in which the user equipment is currently located; and transmitting information to an operator of the local service area network that indicates that the user equipment wants to register with the operator of the local service area network.

Another embodiment of the invention is a computer readable medium encoded with a computer program executable by a processor to perform actions comprising: receiving information at a user equipment from a cellular network base station, the base station having a closed subscriber group signaling indicator indicating off, and the information indicates the availability of a local service area network at a location in which the user equipment is currently located; and transmitting information to an operator of the local service area network that indicates that the user equipment wants to register with the operator of the local service area network.

Another further embodiment of the invention is an apparatus comprising: a receiver configured to receive information at a user equipment from a cellular network base station, the base station having a closed subscriber group signaling indicator indicating off, and the information indicates the availability of a local service area network at a location in which the user equipment is currently located; and a transmitter configured to send information to an operator of the local service area network that indicates that the user equipment wants to register with the operator of the local service area network.

Another further embodiment of the invention is a method comprising: receiving a request in a message from a user equipment at a local service area network to register the user equipment in the local service area network, where the user equipment received information from a base station having closed subscriber group indicator indicating off and the received information indicating network availability; and authenticating the user equipment using a local database and a database of a cellular network operator that is communicated with via a portal.

Another embodiment of the invention is a computer readable medium encoded with a computer program executable by a processor to perform actions comprising: receiving a request in a message from a user equipment at a local service area network to register the user equipment in the local service area network, where the user equipment received information from a base station having closed subscriber group indicator indicating off and the received information indicating network availability; and authenticating the user equipment using a local database and a database of a cellular network operator that is communicated with via a portal.

Another further embodiment of the invention is an apparatus comprising: a receiver configured to receive a request in a message from a user equipment at a local service area network to register the user equipment in the local service area network, where the user equipment received information from a base station having closed subscriber group indicator indicating off and the received information indicating network availability; and a controller configured to authenticate the user equipment using a local database and a database of a cellular network operator that is communicated with via a portal.

### BRIEF DESCRIPTION OF THE DRAWINGS

In the attached Drawing Figures:

FIG. 1 reproduces FIG. 4 of 3GPP TS 36.300 and shows the overall architecture of the E-UTRAN system.

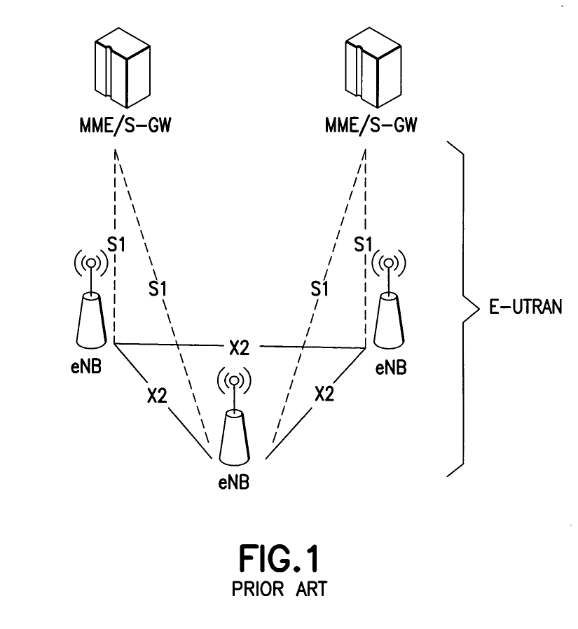

FIG. 2 is an example of an E-UTRAN/LTE radio system environment in which embodiments of the invention may be practiced to advantage.

FIG. 3 shows a simplified block diagram of various electronic devices that are suitable for use in practicing the exemplary embodiments of this invention.

FIG. 4 depicts cell types applicable to various LTE local area scenarios.

FIG. 5 is a diagram that is useful when describing a retailer provided network deployment use case scenario (e.g., within a shopping mall) with LTE pico/micro cells.

FIG. 6 is a diagram that is useful when describing a campus network deployment use case scenario with LTE pico/micro cells.

FIGS. 7, 8 and 9 are each a logic flow diagram that is representative of a method, and the result of a execution of computer program instructions, performed by a cellular network, a user equipment, and a local area network controller, respectively.

### DETAILED DESCRIPTION

The exemplary embodiments of this invention are based at least in part on the realization that a distributed Local IP Breakout solution is an optimum technique to make the LTE radio and the network performance match one another, and to thereby improve the competitiveness of LTE versus alternative broadband wireless access technologies.

The exemplary embodiments of this invention focus at least in part on the deployment of localized services with direct user IP connectivity in local packet switched networks, such as in a shopping mall, fair center, campus, and/or an enterprise utilizing public cells in the PLMN.

The deployment of a Local IP Breakout solution may utilize the CSG principle in certain use cases, but it should foremost provide an ability to break free from the long distance carrier model and enable local calls/services for all subscribers in the PLMN. This opens new opportunities with a wide range of use cases that enable implementing a variety of business models. It is thus desirable that local area scenarios be developed towards an “open networking” model where access to localized services are allowed flexibly both to public and/or closed group users, depending on the use case.

At present the CSG cells/networks are assumed to be part of some PLMN, even if they are not part of the macro layer. As a result, user entry to a CSG cell with manual selection is not directly comparable to a case where a user connects to a non-regulated WLAN hotspot. In the former case several issues should be considered, such as the following:

(A) Security, e.g., the user must be authenticated, authorized and roaming agreements must be in order. For example, the user's home operator may not have a roaming agreement with the local operator that provides the 3G/LTE access. The connecting user maybe a foreign user, thus providing free calls for anyone could, in a worst case scenario, result in lost income from international roaming.

(B) Regulatory issues, such as emergency calls, positioning and legal interception need to be supported.

(C) Users should be accessible by ordinary network originated calls/services when connected to a local network (e.g., location registration in HSS is needed, as is paging when in an idle mode.

Based on the foregoing the inventors have taken the position that CSG networks are by their nature private networks, and should not be engineered for public/open access. Instead, the exemplary embodiments of this invention provide techniques to effectively (and simply) manage CSG members, e.g., for adding a temporary visitor to a CSG group. Exemplary CSG use cases that benefit by the application of the exemplary embodiments include, but are not limited to, residential cell (Home NB) and enterprise networks (e.g., a corporate network built using multiple Femto NBs).

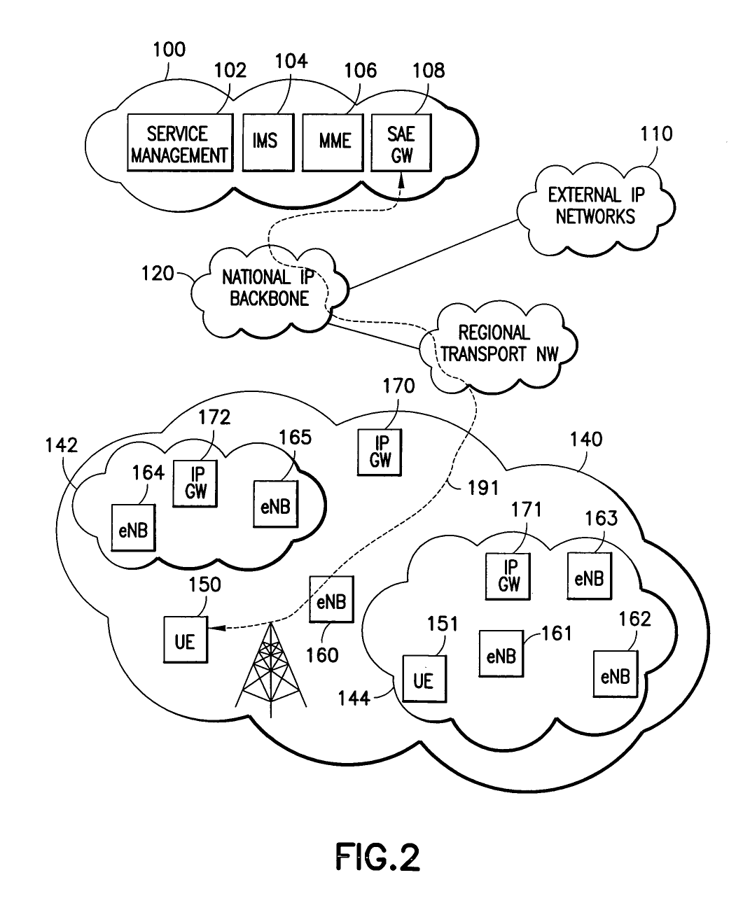

Reference is now made to FIG. 2 for illustrating an exemplary environment for practicing embodiments of this invention. In this example, the radio system is based on LTE/SAE network elements. However, the invention described in these examples is not limited to the LTE/SAE radio systems but can also be implemented in other radio systems, such as HSDPA (high speed downlink packet access), HSUPA (high speed uplink packet access), WIMAX (Worldwide Interoperability for Microwave Access), Internet HSPA, or in other suitable radio systems where there is closed access to certain groups. In addition, the invention can be applied to architectures without local breakout (e.g., current SAE architecture as described in 3GPP TS 23.401, V1.1.0, “3rd Generation Partnership Project; Technical Specification Group Services and System Aspects; GPRS enhancements for E-UTRAN access,” July 2007) or with local breakout.

The exemplary radio system of FIG. 2 comprises a service core 100 of an operator including the following elements: a service management 102, IMS (IP multimedia subsystem) 104, an MME (Mobility Management Entity) 106, and an SAE GW (SAE Gateway) 108.

Traffic between mobile terminals 150, 151 (generally termed user equipment or UEs) and the service core network 100 is carried via a national IP backbone network 120, a regional transport network 130, and a local area aggregation network 140. eNBs (Enhanced node Bs) 160 to 165 of the radio system host the functions for radio resource management: radio bearer control, radio admission control, connection mobility control, and dynamic resource allocation (scheduling). In further exemplary radio systems, any LTE radio access node may be used in place of or in conjunction with the eNBs. As non-limiting examples, such LTE radio access nodes may include LTE femto CPE (e.g., Femto Customer Premises Equipment) and/or LTE pico cells. The MME 106 is responsible for distributing paging messages to the eNBs 160 to 165.

Current radio networks are based on a single switch model. This is implemented in the LTE/SAE network by the SAE GW (SAE Gateway) 108. All calls/services are routed via the SAE GW 108. For example, a connection from a mobile terminal 150 to an external IP networks 110, such as to the Internet 110, is typically guided via a route indicated with a dashed line 191. Variations to this are shown in the Finland Patent Application no. 20075252 referenced above, where connecting to an ordinary IP Gateway 170 to 172 (Access Router) in a corporate network 144 or a specific local area 142 for a local IP breakout from a LTE base station 160 to 165 is described while retaining user access control and SAE GW 108 in the LTE/SAE operator's packet core network 100 (this may apply to the exemplary architecture variations described herein as well). Finland Patent Application no. 20075252 assumes that the registration to the default SAE Bearer services using an IP address from the SAE GW 108 is available, even if not necessarily used for active sessions.

A mobile terminal 150, 151 is configured to detect availability of a closed subscriber network 144 for which it is not a member of the corresponding user group; and to start a network entry to the closed subscriber network if that network is set to ‘open access’.

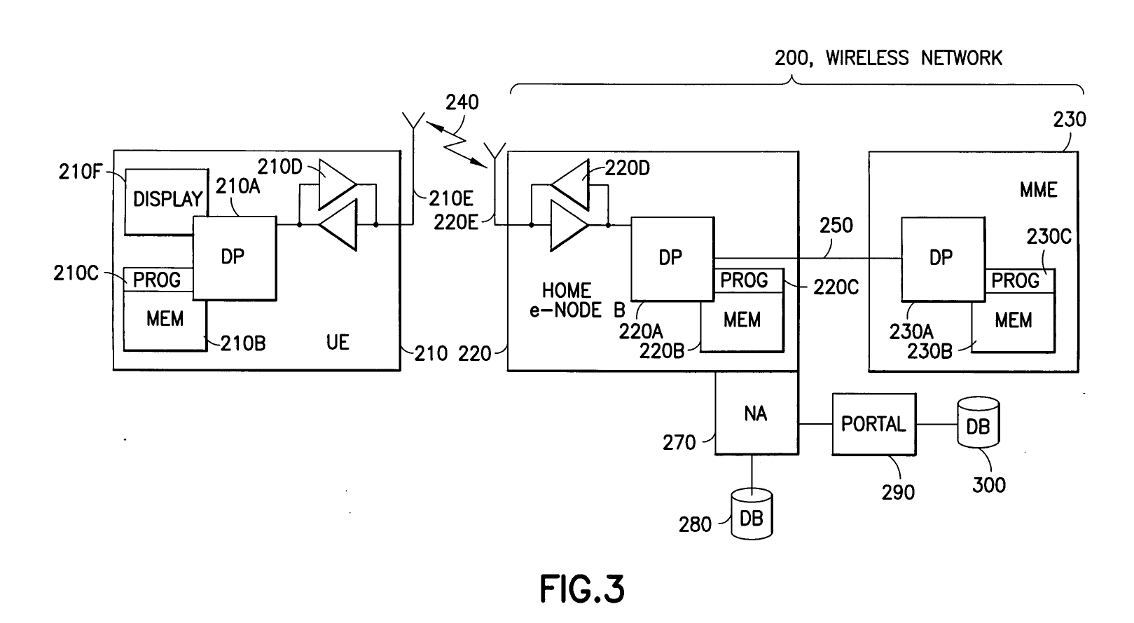

FIG. 3 illustrates simplified block diagrams of various electronic devices that are suitable for use in practicing the exemplary embodiments of this invention. In FIG. 3 a wireless network 200 is adapted for communication between a UE/mobile terminal 210 and a home Node B 220. The network 200 may include a higher network node 230 such as the serving mobile mobility entity/element MME 106, the SAE GW 108, a radio network controller RNC or other radio controller function known by various terms in different wireless communication systems. The UE 210 includes a data processor (DP) 210A, a memory (MEM) 210B that stores a program (PROG) 210C, and a suitable radio frequency (RF) transceiver 210D coupled to one or more antennas 210E (one shown) for bidirectional wireless communications over one or more wireless links 240 with the home Node B 220. The UE 210 further includes a graphical display interface 210F such as a computer screen for displaying information to a user of the device 210 as will be detailed below.

The E-Node B 220 also includes a DP 220A, a MEM 220B, that stores a PROG 220C, and a suitable RF transceiver 220D coupled to one or more antennas 220E. The E-Node B 220 may be coupled via a data path 250 (e.g., S1 interface) to the serving or other GW/MME/RNC 230. The GW/MME/RNC 230 includes a DP 230A, a MEM 230B that stores a PROG 230C, and a suitable modem and/or transceiver (not shown) for communication with the home Node B 230 over the link 250.

At least one of the PROGs 210C, 220C and 230C is assumed to include program instructions that, when executed by the associated DP, enable the electronic device to operate in accordance with the exemplary embodiments of this invention, as described in detail below.

The PROGs 210C, 220C, 230C may be embodied in software, firmware and/or hardware, as is appropriate. In general, the exemplary embodiments of this invention may be implemented by computer software stored in the MEM 210B and executable by the DP 210A of the UE 210 and similar for the other MEM 220B and DP 220A of the e-Node B 12, or by hardware, or by a combination of software and/or firmware and hardware in any or all of the devices shown.

In general, the various embodiments of the UE 210 can include, but is not limited to, mobile stations/mobile terminals, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The MEMs 210B, 220B and 230B may be of any type suitable to the local technical environment and may be implemented using any suitable data storage technology, such as semiconductor-based memory devices, magnetic memory devices and systems, optical memory devices and systems, fixed memory and removable memory. The DPs 210A, 220A and 230A may be controllers and may be of any type suitable to the local technical environment, and may include one or more of general purpose computers, special purpose computers, microprocessors, digital signal processors (DSPs) and processors based on a multi-core processor architecture, as non-limiting examples.

The CSG network concept and broadcast CSG-bit indicating the cell type have been agreed to in 3GPP, and enable various use cases for private networks accessible to a closed subscriber group. However, it would be advantageous if the LTE access supports various use cases for local area scenarios that make new and enhanced business models available to network operators. It is desirable for the localized services to be utilized as well by using the operator owned and administrated network resources, including the public macro, micro and pico cells and supporting their configuration in a flexible manner.

The exemplary embodiments of this invention are based at least in part on a premise that no new bits need be advertised to the UE 210 for mobility control purposes in the Cell System Information (CSI), in addition to the above-mentioned CSG bit. The CCG-bit indicating the cell type may be thought of as an indicator that contains a plurality of bits.

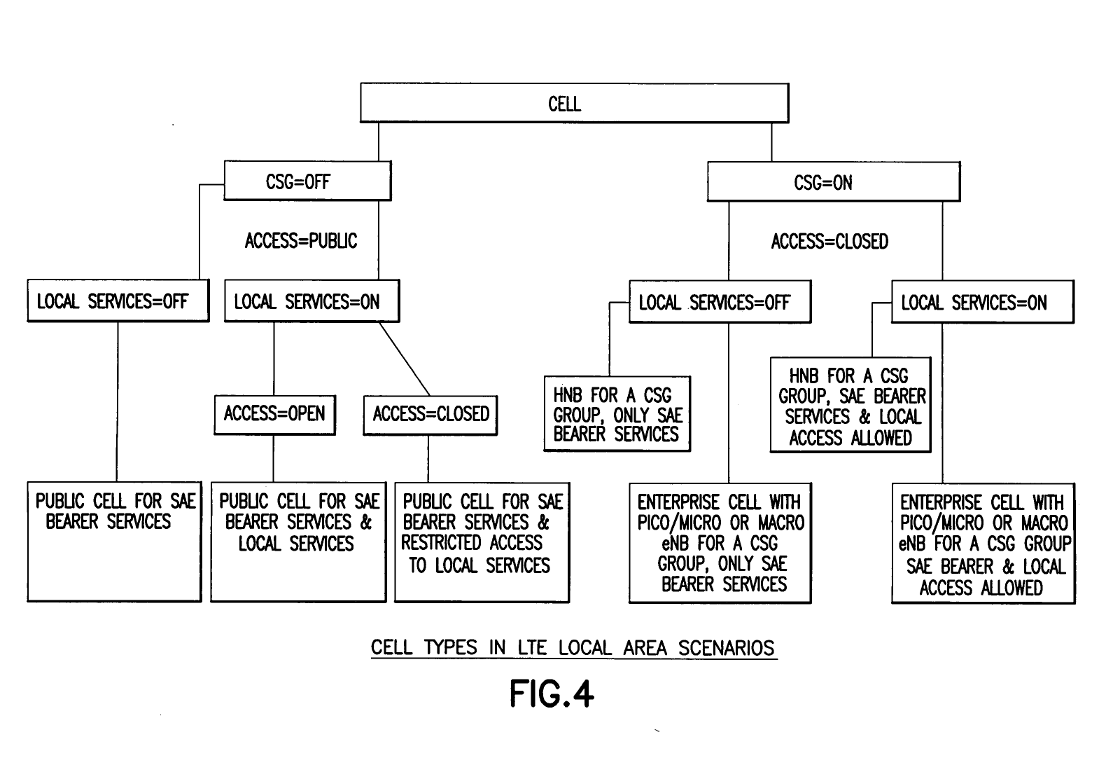

In accordance with an aspect of this invention, FIG. 4 depicts cell types applicable to various LTE local area scenarios, and shows the distinctions between CSG=Off and CSG=On. The examples are given in the context of a retail-sponsored localized service scenario (e.g., in a shopping mall), but are clearly not intended to only this one particular CSG case. In this example there are provided Public Cell (CSG=Off), Local Services=On and Access=Open for entry level Retail Sponsored Communications (RSC) users visiting, for example, a shopping mall, as well as Public Cell (CSG=Off), Local Services=On and Access=Closed for those certain subscribers that meet one or more pre-conditions to obtain no-cost RSC services. The CSG=On branch is suitable for private networks, e.g., home networks, enterprise networks.

In those cases where cells should support both public/open access and restricted access it is desirable that the cells may be configured for public/open access (CSG=Off) as a default condition, and which in addition may provide some localized services either for public or restricted access, e.g., local IP breakout service based on UE 210 subscription and the current location.

In order to support public localized services the network is provided the capability to assist the UE 210 with NAS signaling from the CN for indicating to the UE 210 that is has moved to the localized service coverage area. This may be accomplished, for example, as part of a Tracking Area Update procedure, or as part of an Idle to Active State transition, or as part of an inter-eNB handover (as three non-limiting examples). This feature could be referred to for convenience as “location-based service triggering from the Evolved Packet Core”.

As a non-limiting example, this feature may be implemented in a retail-sponsored localized service scenario (e.g., in a shopping mall) as follows:

(A) Any subscriber that owns a LTE capable UE 210 and a subscription to the cellular operator supporting LTE services, or to a roaming partner, upon moving to the local service area is enabled to continue using public cellular services as usual.

(B) Upon entry to the local service area (e.g., by cell selection or by handover) the network 200 sends via downlink signaling an indication to the UE 210 about available localized services. A first time visitor may accept the offering manually to obtain, e.g., retail-sponsored communication services and to obtain advertisements. The user may enable automatic entry to these services in the UE 210 settings menu(s) when the user visits the retail sponsored network in the future. If the user does not do any action (does not respond to the offer regarding the use of the localized services) the user instead continues using public cellular services with the conventional tariff.

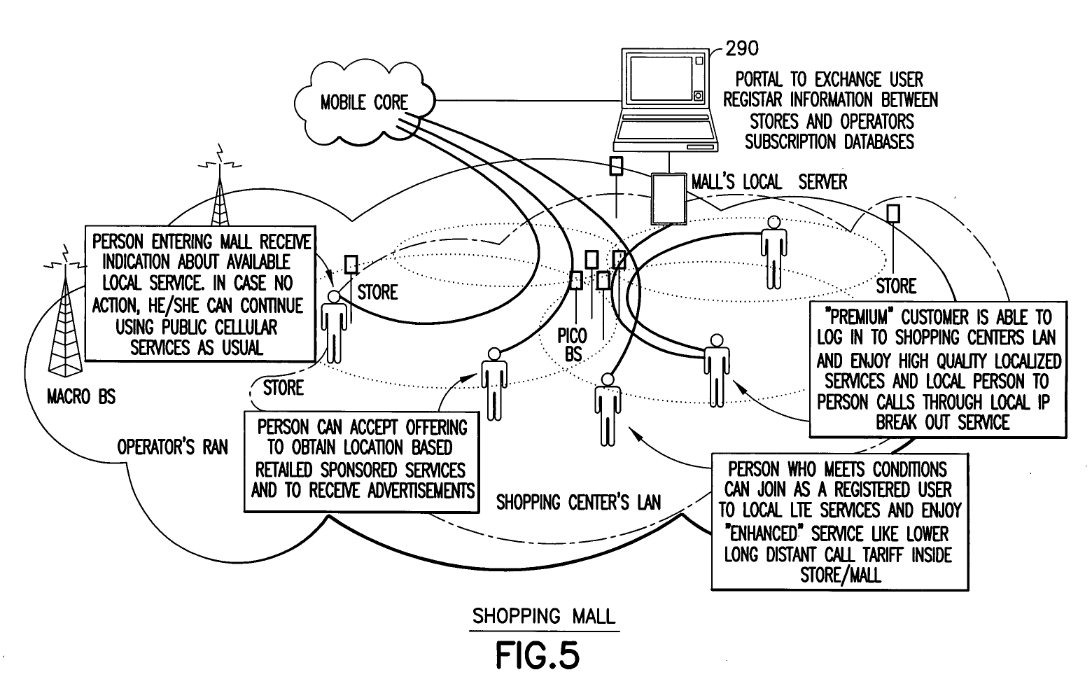

To support premium localized services, e.g., local IP breakout, for those subscribers that meet certain conditions, the following procedures may be followed in the retail sponsored network (e.g., shopping mall). Reference can also be made to FIG. 5.

(A) A subscriber that meets one or more certain conditions (e.g., has purchased some goods or services having some threshold value) is permitted (or invited via macro BS) to join as a registered user for the local LTE services in the retailer sponsored network area. A retailer sponsored network administrator (NA) 270 having a local server maintains a sponsored user database (DB) 280 (see FIG. 3) that exchanges information with the network operator's 200 subscription database (DB) 300 using a portal 290, or the user himself sends a message, such as a SMS message, with the given instructions to obtain local access rights for the UE 210 in the retailer sponsored network area.

(B) With the given instructions and/or received configuration data in SMS, the user is enabled to configure the UE 210 to perform automatic (or manual) network entry to the local IP breakout services (e.g., inexpensive local calls and/or direct data access to the LAN/local servers run by the retailer sponsored network administrator). In addition, less expensive long distance calls, using the normal network operator's SAE bearer services, may become enabled while visiting in the retailer sponsored network area.

Describing now the retail sponsored local network in greater detail, what is now described is a use case for a retail sponsored network deployment scenario with LTE pico/micro cells (see FIG. 5).

### Retail Sponsored Network Definition:

A retail sponsored network is an autonomous network under the management of a single entity that exists in a shopping mall, or more generally within a local geographic area such as a commercial center, airport, or a city center. While the network may be managed by a single entity, it may be sponsored by a plurality of retailers or local communities. A retail sponsored network allows retailers to offer localized communication services to improve their sales. This use case integrates a local retail sponsored network into the public cellular mobile network.

### Use Case:

A retail sponsored network administrator(s) and cellular operator(s) agree to deploy LTE utilizing pico/micro cells within the local geographic area to provide access to the public cellular mobile network and to the retail sponsored network with location-based (e.g., in-area, in-store) services targeted to public, occasional, or frequent visitors.

The LTE cells within the retail sponsored network are open for public access since they are part of the operator(s) PLMN. The ordinary cellular and enhanced localized IMS services can be enjoyed in the local network coverage by any user that is a subscriber to the cellular operator or that is a subscriber to a roaming partner of the cellular operator.

A location-based (in-store) service tariff may be offered to attract more or new customers to visit a particular store and/or to remain longer in the store. In addition, those subscribers that meet certain conditions are allowed to enjoy less expensive/free local calls (peer-to-peer) and high performance data access to locally administered services and to the Internet using their LTE terminals while located in the retail sponsored network coverage area.

### Preconditions:

The local radio network utilizing LTE pico/micro cells in the retail sponsored area may be planned by the cellular operator in order to provide proper coverage, capacity and to minimize interference. The local network may use a different frequency than the macro overlay in the neighborhood if desired. Also, existing macro overlay cells can be used for local access. Note that multiple cellular operators may share the frequency that is used for a local retail sponsored network.

As the access to the LTE pico/micro cells in the local retail sponsored network is public by default, the operator in an OAM (operations and maintenance) center may create public cells grouped to their own TA. In this case regular cellular subscribers within the retailer sponsored network coverage area are allowed to camp on the cells in the local network. Note that the radio coverage of the TA is preferably limited to the retailer sponsored area, so that most of the normal users are registered community members and the remainder are occasional or regular visitors.

The retail sponsored network administrators and operator use the portal 290 to exchange user information for those subscribers that are entitled to promotional and other benefits, e.g., to enjoy less expensive operator provided services and/or to gain local access to the retail sponsored network (local IP breakout).

The operator may arrange means to obtain temporary local access rights to certain visitors that agree to accept advertisements, e.g., to use SMS. The granted access rights may be different for temporary visitors, e.g., they may provide only local Internet access or local peer to peer calls (also video) with family members.

### Description:

Any subscriber having an LTE terminal (e.g., the UE 210) and a subscription to the cellular operator running the LTE services in the retail sponsored network, or to a roaming partner, that moves into the retail sponsored area can continue using public cellular services as usual.

Upon entry to the retail sponsored network (e.g., by cell selection, or handover) the network sends an indication to the UE 210 about available retail sponsored communication services. A first time visitor may accept the offering manually to obtain retail sponsored communication services and may agree to receive advertisements. The user may enable automatic entry to these services in the UE settings when visiting the retail sponsored network in the future. If the user does not take any action the user simply continues using the public cellular services with the ordinary tariffs in effect.

A subscriber that meets some certain criterion or criteria (e.g., has made a purchase that exceeds some monetary value) is allowed to join as a registered user for the local LTE services in the retailer sponsored network area. The retailer sponsored network administrator maintains the sponsored user database 280 and exchanges information with the operator's subscription database 300 using the portal 290, or the user sends the message, e.g., the SMS message, with instructions that are provided to obtain local access rights for the UE 210 in the retailer sponsored network area.

With the given instructions and/or received configuration data (e.g., by SMS) the user is enabled to configure the UE 210 to perform automatic (or manual) network entry to the local IP breakout services (e.g., to obtain inexpensive local calls and direct data access to the retailer sponsored network). Also, less expensive long distance calls using ordinary SAE Bearer Services may become enabled.

### Post Conditions:

Once the user is authenticated, has obtained a local IP address, and is connected to the retailer sponsored network with the user's LTE terminal (e.g., the LTE compatible UE 210), the user is enabled the opportunity to receive services provided by the retailer sponsored network administrator(s) and cellular operator.

Note that user authentication and authorization to the retailer sponsored network should be performed as part of the network entry procedure to the local IP breakout towards the local AAA server in the retailer sponsored network. If local authentication fails the user is blocked from obtaining local IP breakout services by the eNB 220. A handover to the macro layer can be performed when the UE 210 moves out of the retailer sponsored network, and the user may perform a manual detach from the retailer sponsored network.

Note also that regulatory issues such as emergency calls, positioning, and legal interception are supported as in a conventional network case since the conventional SAE Bearer Services are always available in parallel with the localized services in the retailer sponsored network area.

Retailer sponsored network area visitors are accessible by ordinary network originated calls/services using SAE Bearer services also when connected to the retailer sponsored network (as location registration in the HSS and the operator's core network is always up-to-date). In addition, the user may enjoy optimally routed and free UE-to-UE communication services (e.g., VoIP/data) locally within the retailer sponsored network area.

It should be appreciated that the use of public cells provides a more flexible solution than creating a CSG network within the retailer sponsored network area (e.g., within a shopping mall). In addition, if CSG cells were to operate on the same carrier as that of the “open” network they could, in the CSG coverage area, prevent the use of open network service for other UEs 210 that are not allowed to access the CSG cells without manual intervention (assuming, for example, a largely indoor environment with strong coverage by the CSG cells and weaker coverage by conventional open cell(s)).

The use of the pico/micro cells provides a carrier grade solution without capacity limitations.

The operator's subscriber database 300 may be leveraged to assist retailers in promoting outlets and products to increase sales. For example, if a certain subscriber belongs to a family member group for making lower tariff cellular calls, the local access rights in the retailer sponsored communication services may be given automatically to all of the family members.

In addition, the use of operator services may be an incentive to use retail sponsored network services.

There are a number of possible (non-limiting) examples of high performance local data access (local IP breakout) in the retailer sponsored network scenario.

As one example, fast digital image transfer can occur from the LTE terminal (UE 210) to obtain prints from a local photo shop. This can occur at any location within the retailer sponsored network area, not just a certain hot spots.

As another example, the user may be able to listen to music (e.g., by streaming, restricted to, for example, a fraction of the length of a song) from a local music retailer's database when making a decision to buy a CD.

As another example, the user may be enabled to receive a fast music transfer (download) of a purchased song from the local music retailer's database. The user/customer can be enabled to either to download to the UE 210 the content of a purchased CD in MP3 or some other format, or the user/customer may simply purchase one or more titles in MP3 format (without actually receiving the CD).

As another example, the user may be enabled to view a video clip (e.g., a streaming trailer) from local store's database before making a decision to buy a DVD, or a movie to be watched using the LTE terminal (MP4, etc).

As other examples, the user may be enabled to engage in gaming with low latency (e.g., server and one or more opponents in the same LAN), and/or to browse local store's web-pages to search items and compare prices, and/or to use free and fast local Internet access for various purposes, and/or to engage in lowest cost push-to-talk or video calling with family members in the retailer sponsored network area (locally optimized direct routing).

Note that the implementation of these exemplary embodiments in the context of LTE/SAE may involve software enhancements to the HSS, MME 230, e-NodeB 220 and the UE 210. Also the portal 290 for exchanging information between operator's subscription database 300, IMS and the locally administered user database 280 and local service functionality may be provided.

The exemplary embodiments are described in even further detail in the following two exemplary and non-limiting use cases that achieve local access utilizing public cells in the PLMN.

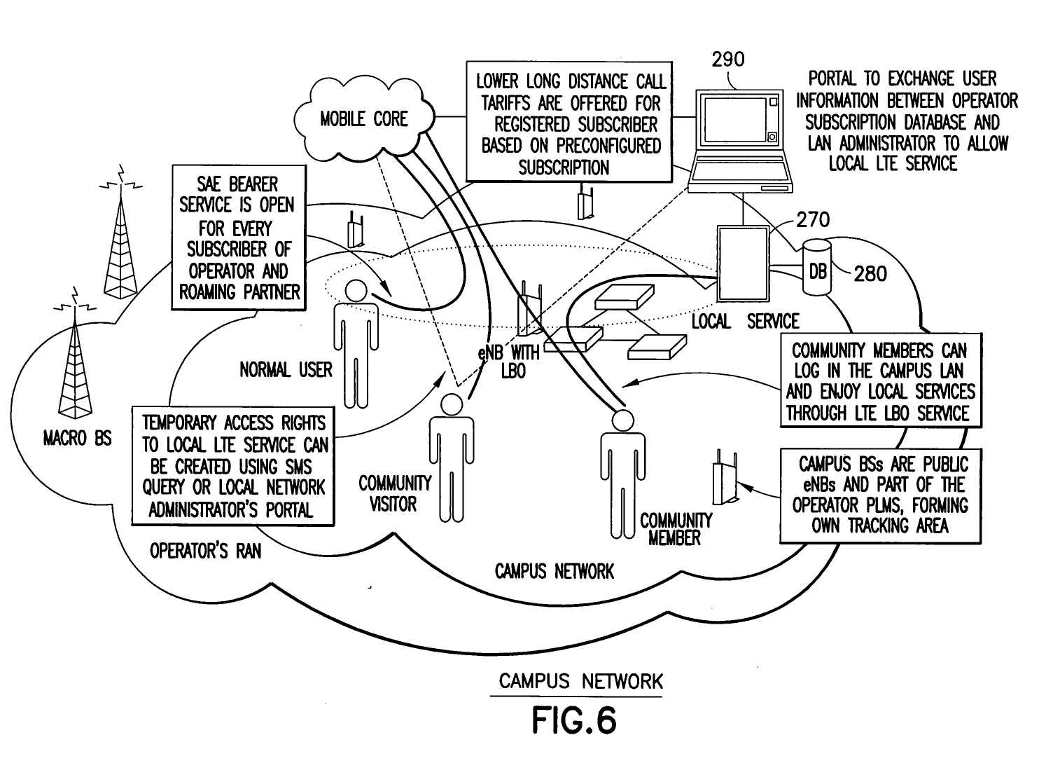

Use Case Campus network deployment scenario with LTE pico/micro cells (FIG. 6)

### Campus Network Definition:

A campus network is defined herein for convenience, and not by way of limitation, as an autonomous network under the management of a single entity that exists on a university campus or within a local geographic area such as a business park, a government center, a research center, or a medical center. While the network may be managed by a single entity, it may be used by different organizations. The campus network may provide an access path into a larger network, such as a metropolitan area network or the Internet. This use case shows the integration of the campus network into a public cellular mobile network.

### Use Case:

Assume for this use case that the campus network administrator(s) and cellular operator(s) agree to deploy LTE to provide access to public cellular mobile network and campus network with inexpensive/free calls and high performance local data access targeted to community members by the use of LTE pico/micro cells within the local geographic area.

The LTE cells within the campus area are open for public access as being part of the operator(s) PLMN. The conventional SAE Bearer Services may be used in the campus area by any user who is a subscriber to the operating cellular operator, or a subscriber to a roaming partner. The registered community members can enjoy less expensive long distance calls, free local calls and high performance data access to the campus network and to the Internet using their LTE terminals.

### Preconditions:

The local radio network utilizing LTE pico/micro cells in the campus area is planned by the cellular operator 200 in order to provide proper coverage, capacity and to minimize interference. The local campus network may use a different frequency than the macro overlay in the same geographical area if desired. Also existing macro overlay cells may be used for local access. It is within the scope of these exemplary embodiments that multiple cellular operators may share the frequency that is used for the local network.

As the access to the LTE pico/micro cells in the local campus network is public by default, the operator in an OAM (operations and maintenance) center may create public cells grouped to their own TA. In this case regular cellular subscribers within the campus network coverage area are allowed to camp on the cells in the local network. Note that the radio coverage of the TA is preferably limited to the campus area, so that most of the normal users are registered community members and the remainder are occasional or regular visitors.

The campus network administrator(s) and operator(s) employ the portal 290 to exchange user information for the community members, and the visitors to the community, that are allowed to gain local access to the campus network and to enjoy, for example, less expensive long distance calls using local LTE access.

The operator may arrange to obtain temporary local access rights for the UEs 210 belonging to visitors by using, for example, SMS messaging. The granted access rights may be different for the temporary visitors, e.g., limited to just enabling local Internet access (and not less expensive long distance calls).

### Description:

A community member having a LTE terminal (e.g., an LTE-compatible UE 210) and a subscription to the cellular operator providing the LTE services in the campus network, or to a roaming partner of the cellular operator, is allowed to join to as a registered user for the local LTE services in the campus area. The campus network administrator enters the user into the database 280 and to the operator's subscription database 300 using the portal 290, or the user himself send a message, such as a SMS message, with provided instructions to obtain local access rights for the UE 210 in the campus area.

With the given instructions and/or received configuration data (e.g., by SMS) the user is enabled to configure the UE 210 to perform automatic (or manual) network entry to the local IP breakout services (e.g., to obtain inexpensive local calls and direct data access to the campus network). Also, less expensive long distance calls using ordinary SAE Bearer Services may become enabled.

### Post Conditions:

Once the user is authenticated, has obtained a local IP address, and is connected to the campus network with the user's LTE terminal (e.g., the LTE compatible UE 210), the user is enabled the opportunity to receive services provided by the campus network administrator(s) and cellular operator.

Note that user authentication and authorization to the campus network should be performed as part of the network entry procedure to the local IP breakout towards the local AAA server in the campus network. If local authentication fails the user is blocked from obtaining local IP breakout services by the eNB 220. A handover to the macro layer can be performed when the UE 210 moves out of the campus area, and the user may perform a manual detach from the campus network.

Note that regulatory issues such as emergency calls, positioning, and legal interception are supported as in a conventional network case since the conventional SAE Bearer Services are always available in parallel with the localized services in the campus network.

Community members are accessible by ordinary network originated calls/services using SAE Bearer services also when connected to the campus network (as location registration in the HSS and the operator's core network is always up-to-date). In addition, the user may enjoy optimally routed and free UE-to-UE communication services (e.g., VoIP/data) locally within the campus area.

As the majority of the users in the campus area are registered community members they can benefit from high e2e performance in the local access, even though the LTE cells are shared with normal subscribers as part of the PLMN.

Use Case Fair Center Deployment Scenario with LTE Pico Cells

### Use Case:

A fair center organizer and the network operator agree to deploy LTE to provide Internet services and inexpensive/free calls to visitors utilizing LTE pico cells/eNBs in a fair center area. Services provided via these LTE pico cells may be different than the services provided via the macro network overlay, and the pricing may be different as well. Because of this, and to provide enhanced performance, the LTE pico cells in the fair trade's network may operate with restricted access, where normal network subscribers in the vicinity of the fair center area and within the coverage of the fair area are not able to join to the closed local network without authorization by the fair organizer/LTE operator and user interaction. Unauthorized users, or those who have permission but have not joined or do not care to join to the local services in the fair area, are enabled to continue using public services normally from the macro (e.g., LTE cellular network) overlay. Only those visitors who have been granted permission, and who desire to, are enabled to consume localized services in the fair center area. Note that the fair center may be associated with any type of gathering, including conferences, seminars, promotional events, meetings of user groups and the like.

### Preconditions:

The local radio network utilizing LTE pico cells in the fair center area is planned in order to provide proper coverage and capacity without interfering with the macro overlay, and may use a different frequency than the macro overlay if desired. The local network may be a permanent or a temporary installation depending on the case.

As the access to the LTE pico cells in the local fair center network is restricted by default, the operator in the OAM center may create a CSG network, or public cells grouped to own TA. In the latter case the cell barred state is set on in order to avoid normal subscribers camping on the cells in the local network. Note in this regard that the radio coverage of the local network is typically limited to the premises of the fair or a compound that is not open to the general public, thereby restricting the number of normal subscribers who may attempt to camp on the local area cells.

The fair organizer/operator is assumed to create a required number of temporary user identifiers for the visitors to enter the fair center network. The information for obtaining a temporary user identifier may be printed on an admission ticket or other materials given to visitors. The operator may arrange means to obtain temporary local access rights for the UEs 210 such as by using SMS messaging.

### Description:

When the fair opens those visitors willing to consume local LTE services by the fair organizer and the network operator send a message, such as a SMS message, via a macro cell in accordance with the instructions provided in order to obtain temporary local access rights for the visitor's UE 210. At this point the user becomes either a member of a CSG group or is added to an allowed UE list in barred cells. After this the user is able to select the local fair center network manually in order to consume localized LTE services in the fair center area. The various issues discussed above related to security, handover and the like apply equally to this particular use case.

Note that the local fair center network may be on the same or a different frequency as the macro overlay network. Note as well that this use case may be supported without introducing the CSG or CSG-like concept, as the only issues that need to resolved are how best to add temporary users into the CSG group or allowed UEs into barred cells.

As can be appreciated, one advantage that results from the use of these exemplary embodiments is that pre-existing mobility control mechanisms can be applied to enable various new uses and business cases with minimal standardization effort in 3GPP.

Based on the foregoing it should be apparent that the exemplary embodiments of this invention provide a method, apparatus and computer program(s) to provide the UE 210 with access to cells within a localized geographical area contained within an area serviced by macro cells of a cellular network operator.

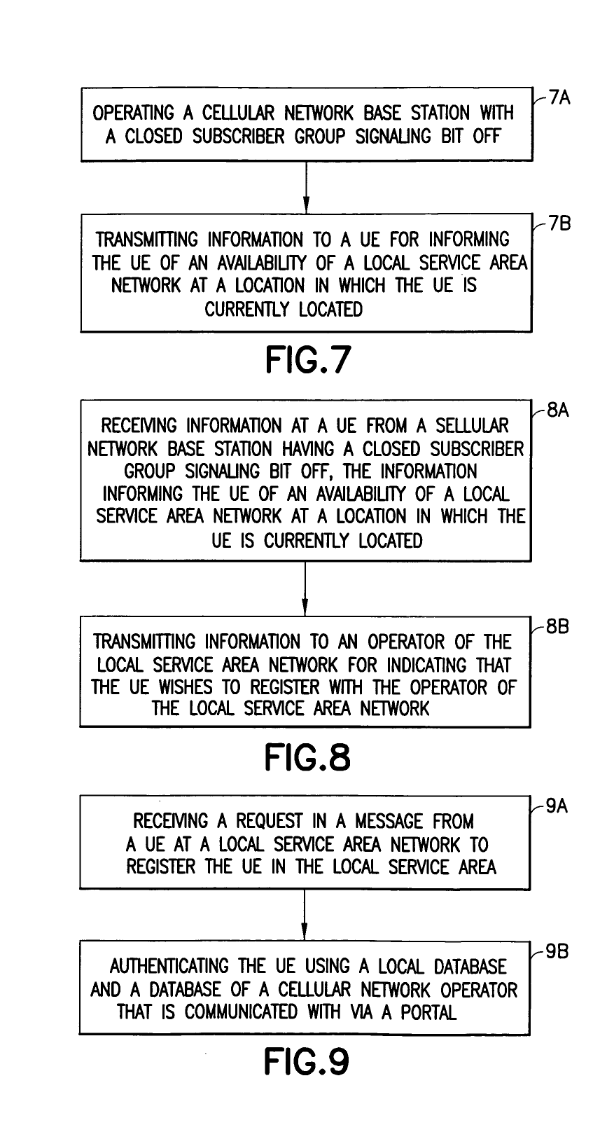

Referring to FIG. 7, a method includes (Block 7A) operating a cellular network base station with a closed subscriber group signaling bit Off, and (Block 7B) transmitting information to a UE for informing the UE of an availability of a local service area network at a location in which the UE is currently located.

In the method of the preceding paragraph, where transmitting information to a UE occurs using one of a Tracking Area Update procedure, as part of an Idle to Active State transition procedure, or as part of an inter-base station handover procedure.

In the method of the preceding paragraphs, where the local service area network provides at least an IP breakout service for the UE for obtaining data from or sending data to a local server of the local network area.

In the method of the preceding paragraphs, where the local service area network provides at least an IP breakout service for the UE for obtaining data from or sending data to a remote server reachable through the Internet.

In the method of the preceding paragraphs, where the local service area network provides at least a reduced cost calling service for the UE.

In the method of the preceding paragraphs, where base stations of the local service area network use a same carrier frequency as the cellular network base station.

In the method of the preceding paragraphs, where base stations of the local service area network use a different carrier frequency than the cellular network base station.

In the method of the preceding paragraphs, where an operator of the local service area network receives a message from the UE indicating that the UE wishes to register with the operator of the local service area network.

In the method of the preceding paragraph, where the operator of the local service area network, in response to receiving the message, authenticates the UE using a local database and a database of the cellular network operator that is communicated with via a portal.

Further in accordance with these exemplary embodiments, and referring to FIG. 8, a method includes (Block 8A) receiving information at a UE from a cellular network base station having a closed subscriber group signaling bit Off, the information informing the UE of an availability of a local service area network at a location in which the UE is currently located; and (Block 8B) transmitting information to an operator of the local service area network for indicating that the UE wishes to register with the operator of the local service area network.

In the method of the preceding paragraph, where the receiving the information at the UE occurs during one of a Tracking Area Update procedure, as part of an Idle to Active State transition procedure, or as part of an inter-base station handover procedure.

In the method of the preceding paragraphs, where the local service area network provides at least an IP breakout service for the UE for obtaining data from or sending data to a local server of the local network area.

In the method of the preceding paragraphs, where the local service area network provides at least an IP breakout service for the UE for obtaining data from or sending data to a remote server reachable through the Internet.

In the method of the preceding paragraphs, where the local service area network provides at least a reduced cost calling service for the UE.

In the method of the preceding paragraphs, where the UE operates with base stations of the local service area network using a same carrier frequency as with the cellular network base station.

In the method of the preceding paragraphs, where the UE operates with base stations of the local service area network using a different carrier frequency than with the cellular network base station.

In the method of the preceding paragraphs, where the information is transmitted to the operator of the local service area network using a SMS message.

In the method of the preceding paragraph, where the operator of the local service area network, in response to receiving the message, authenticates the UE using a local database and a database of the cellular network operator that is communicated with via a portal.

Further in accordance with these exemplary embodiments, and referring to FIG. 9, a method includes (Block 9A) receiving a request in a message from a UE at a local service area network to register the UE in the local service area; and (Block 9B) authenticating the UE using a local database and a database of a cellular network operator that is communicated with via a portal.

In the method of the preceding paragraphs, where the local service area network provides at least an IP breakout service for the UE for obtaining data from or sending data to a local server of the local network area.

In the method of the preceding paragraphs, where the local service area network provides at least an IP breakout service for the UE for obtaining data from or sending data to a remote server reachable through the Internet.

In the method of the preceding paragraphs, where the local service area network provides at least a reduced cost calling service for the UE.

In the method of the preceding paragraphs, where base stations of the local service area network use a same carrier frequency as a cellular network base station.

In the method of the preceding paragraphs, where base stations of the local service area network use a different carrier frequency than a cellular network base station.

In the method of the preceding paragraphs, where the request is received in a SMS message.

The various blocks shown in FIGS. 7, 8 and 9 may be viewed as method steps, and/or as operations that result from operation of computer program code, and/or as a plurality of coupled logic circuit elements constructed to carry out the associated function(s). Various means are thus provided for accomplishing the various method steps.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the inventions may be practiced in various components such as integrated circuit chips and modules.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

For example, while the exemplary embodiments have been described above largely in the context of the E-UTRAN (UTRAN-LTE) system, it should be appreciated that the exemplary embodiments of this invention are not limited for use with only this one particular type of wireless communication system, and that they may be used to advantage in other wireless communication systems.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

1. A method comprising:
operating a cellular network base station with closed subscriber group indicator indicating off; and
transmitting information to a user equipment indicating the availability of a local service area network at a location in which the user equipment is currently located.

2. The method of claim 1, where transmitting information to the user equipment occurs using one of:
(a) a tracking area update procedure,
(b) an idle to active state transition procedure, or
(c) an inter-base station handover procedure.

3. The method as in claim 1, where the local service area network provides at least one of an internet protocol breakout service for the user equipment for obtaining data from or sending data to a local server of the local service area network or an internet protocol breakout service for the user equipment for obtaining data from or sending data to a remote server reachable through the internet.

4. The method as in claim 1, where operating the cellular network base station is in either the same carrier frequency as base stations of the local service area network or in a different carrier frequency than base stations of the local service area network.

5. The method as in claim 1, where the local service area network provides at least a reduced cost calling service for the user equipment.

6. A computer readable medium encoded with a computer program executable by a processor to perform actions comprising:
operating a cellular network base station with closed subscriber group indicator indicating off; and
transmitting information to a user equipment indicating the availability of a local service area network at a location in which the user equipment is currently located.

7. The computer readable medium encoded with a computer program of claim 6, where transmitting information to the user equipment occurs using one of:
(a) a tracking area update procedure,
(b) an idle to active state transition procedure, or
(c) an inter-base station handover procedure.

8. The computer readable medium encoded with a computer program as in claim 6, where the local service area network provides at least one of an internet protocol breakout service for the user equipment for obtaining data from or sending data to a local server of the local service area network or an internet protocol breakout service for the user equipment for obtaining data from or sending data to a remote server reachable through the internet.

9. The computer readable medium encoded with a computer program as in claim 6, where operating the cellular network base station is in either the same carrier frequency as base stations of the local service area network or in a different carrier frequency than base stations of the local service area network.

10. The computer readable medium encoded with a computer program as in claim 6, where the local service area network provides at least a reduced cost calling service for the user equipment.

11. An apparatus comprising:
a controller configured to operate a cellular network base station with closed subscriber group indicator indicating off; and
a transmitter configured to send information to a user equipment indicating the availability of a local service area network at a location in which the user equipment is currently located.

12. The apparatus of claim 11, where the transmitter sends information to the user equipment using one of:
(a) a tracking area update procedure,
(b) an idle to active state transition procedure, or
(c) an inter-base station handover procedure.

13. The apparatus as in claim 11, where the local service area network provides at least one of an internet protocol breakout service for the user equipment for obtaining data from or sending data to a local server of the local service area network or an internet protocol breakout service for the user equipment for obtaining data from or sending data to a remote server reachable through the internet.

14. The apparatus as in claim 11, where the controller operates the cellular network base station in either the same carrier frequency as base stations of the local service area network or in a different carrier frequency than base stations of the local service area network.

15. The apparatus as in claim 11, where the local service area network provides at least a reduced cost calling service for the user equipment.

16. A method comprising:
receiving information at a user equipment from a cellular network base station, the base station having a closed subscriber group signaling indicator indicating off, and the information indicates the availability of a local service area network at a location in which the user equipment is currently located; and
transmitting information to an operator of the local service area network that indicates that the user equipment wants to register with the operator of the local service area network.

17. The method of claim 16, where receiving the information occurs during one of:
(a) a tracking area update procedure,
(b) an idle to active state transition procedure, or
(c) an inter-base station handover procedure.

18. The method as in claim 16, where the local service area network provides at least one of an internet protocol breakout service for the user equipment for obtaining data from or sending data to a local server of the local service area network or an internet protocol breakout service for the user equipment for obtaining data from or sending data to a remote server reachable through the internet.

19. The method as in claim 16, where the local service area network provides at least a reduced cost calling service for the user equipment.

20. The method as in claim 16, where the user equipment operates with base stations of the local service area network that have either the same or different carrier as with the cellular network base station.

21. The method as in claim 16, where the information is transmitted to the operator of the local service area network using a short message service message.

22. A computer readable medium encoded with a computer program executable by a processor to perform actions comprising:
receiving information at a user equipment from a cellular network base station, the base station having a closed subscriber group signaling bit indicator indicating off, and the information indicates the availability of a local service area network at a location in which the user equipment is currently located; and
transmitting information to an operator of the local service area network that indicates that the user equipment wants to register with the operator of the local service area network.

23. The computer readable medium encoded with a computer program of claim 22, where receiving the information occurs during one of:
(a) a tracking area update procedure,
(b) an idle to active state transition procedure, or
(c) an inter-base station handover procedure.

24. The computer readable medium encoded with a computer program as in claim 22, where the local service area network provides at least one of an internet protocol breakout service for the user equipment for obtaining data from or sending data to a local server of the local service area network or an internet protocol breakout service for the user equipment for obtaining data from or sending data to a remote server reachable through the internet.

25. The computer readable medium encoded with a computer program as in claim 22, where the local service area network provides at least a reduced cost calling service for the user equipment.

26. The computer readable medium encoded with a computer program as in claim 22, where the user equipment operates with base stations of the local service area network that have either the same or different carrier as with the cellular network base station.

27. The computer readable medium encoded with a computer program as in claim 22, where the information is transmitted to the operator of the local service area network using a short message service message.

28. An apparatus comprising:
a receiver configured to receive information at a user equipment from a cellular network base station, the base station having a closed subscriber group signaling indicator indicating off, and the information indicates the availability of a local service area network at a location in which the user equipment is currently located; and
a transmitter configured to send information to an operator of the local service area network that indicates that the user equipment wants to register with the operator of the local service area network.

29. The apparatus of claim 28, where the receiver receives the information during one of:
(a) a tracking area update procedure,
(b) an idle to active state transition procedure, or
(c) an inter-base station handover procedure.

30. The apparatus as in claim 28, where the local service area network provides at least one of an internet protocol breakout service for the user equipment for obtaining data from or sending data to a local server of the local service area network or an internet protocol breakout service for the user equipment for obtaining data from or sending data to a remote server reachable through the internet.

31. The apparatus as in claim 28, where the local service area network provides at least a reduced cost calling service for the user equipment.

32. The apparatus as in claim 28, further comprising a controller configured to operate with base stations of the local service area network that have either the same or different carrier as with the cellular network base station.

33. The apparatus as in claim 28, where the transmitter sends the information in a short message service message.

34. A method comprising:
receiving a request in a message from a user equipment at a local service area network to register the user equipment in the local service area network, where the user equipment received information from a base station having closed subscriber group indicator indicating off and the received information indicating network availability; and
authenticating the user equipment using a local database and a database of a cellular network operator that is communicated with via a portal.

35. The method of claim 34, where the local service area network provides at least one of an internet protocol breakout service for the user equipment for obtaining data from or sending data to a local server of the local service area network or an internet protocol breakout service for the user equipment for obtaining data from or sending data to a remote server reachable through the internet.

36. The method as in claim 34, where the local service area network provides at least a reduced cost calling service for the user equipment.

37. The method as in claim 34, where the request is received in a short message service message.

38. A computer readable medium encoded with a computer program executable by a processor to perform actions comprising:
receiving a request in a message from a user equipment at a local service area network to register the user equipment in the local service area network, where the user equipment received information from a base station having closed subscriber group indicator indicating off and the received information indicating network availability; and
authenticating the user equipment using a local database and a database of a cellular network operator that is communicated with via a portal.

39. The computer readable medium encoded with a computer program as in claim 38, where the local service area network provides at least one of an internet protocol breakout service for the user equipment for obtaining data from or sending data to a local server of the local service area network or an internet protocol breakout service for the user equipment for obtaining data from or sending data to a remote server reachable through the internet.

40. The computer readable medium encoded with a computer program as in claim 38, where the local service area network provides at least a reduced cost calling service for the user equipment.

41. The computer readable medium encoded with a computer program as in claim 38, where the request is received in a short message service message.

42. An apparatus comprising:
a receiver configured to receive a request in a message from a user equipment at a local service area network to register the user equipment in the local service area network, where the user equipment received information from a base station having closed subscriber group indicator indicating off and the received information indicating network availability; and
a controller configured to authenticate the user equipment using a local database and a database of a cellular network operator that is communicated with via a portal.

43. The apparatus of claim 42, where the local service area network provides at least one of an internet protocol breakout service for the user equipment for obtaining data from or sending data to a local server of the local service area network or an internet protocol breakout service for the user equipment for obtaining data from or sending data to a remote server reachable through the internet.

44. The apparatus as in claim 42, where the local service area network provides at least a reduced cost calling service for the user equipment.

45. The apparatus as in claim 42, where the request is received in a short message service message.
